(19) United States
(12) Patent Application Publication
(10) Pub. No.: US 2016/0162980 A1
(43) Pub. Date: Jun. 9, 2016

(54) INTERNET OF THINGS DEVICE MANAGEMENT PLATFORM

(71) Applicant: Opnia LLC, Minneapolis, MN (US)

(72) Inventor: Brook Steven Oldre, Bloomington, MN (US)

(21) Appl. No.: 14/964,253

(22) Filed: Dec. 9, 2015

Related U.S. Application Data
(60) Provisional application No. 62/089,824, filed on Dec. 9, 2014.
(60) Provisional application No. 62/154,305, filed on Apr. 29, 2015.

(51) Int. Cl. G06Q 30/06; H04B 17/318; G01S 1/02; H04W 48/16; H04W 4/04

(52) U.S. Cl. CPC G06Q 30/0641; H04W 48/16; H04W 4/043; G01S 1/02; H04B 17/318

(57) ABSTRACT

An Internet of Things management system is described that allows organizations to remotely monitor and configure a fleet of devices. In one embodiment, the system includes a services layer executed by a computing platform that communicates with mobile devices such as smart phones via a network interface. Beacon devices may be deployed to broadcast a location identification within an organization's site to the mobile devices, which location may then be communicated to the services layer.

### PRIORITY CLAIM

This application claims priority to U.S. Provisional Patent Application Ser. No. 62/089,824 filed Dec. 9, 2014 and to U.S. Provisional Patent Application Ser. No. 62/154,305 filed Apr. 29, 2015, which are incorporated herein by reference in their entirety.

### BACKGROUND

The Internet of Things is an idea that devices (machines) in the world around us will be smart. These things will sense their environment and exchange data over the Internet. The payoff for people will be a world that will conform and react to their presence and preferences. This will make a world that works harder for the people in it. The world will become more efficient and personalized for people. A simple example of this would be an elevator that knows you are approaching and will bring itself to your floor before you have called it. This would save you time in waiting for the elevator and could be accomplished by a few machines sensing the world and exchanging data.

### BRIEF DESCRIPTION OF THE DRAWINGS

FIG. 1 illustrates a graphic that shows each layer in the services according to some embodiments.

FIG. 2 illustrates a typical interaction between the beacon and the Mobile Shopper device according to some embodiments.

FIG. 3 is a graphic that shows the interaction that happens when the Mobile Shopper stays in a Zone for longer than the specified Zone Length Tolerance according to some embodiments.

FIG. 4 illustrates the interaction between the Mobile Shopper app, the Guest Assist application and the platform services according to some embodiments.

FIG. 5 illustrates a heatmap of a store showing how many Mobile Shopper devices are interacting with each zone according to some embodiments.

FIG. 6 illustrates testing two similar endcap designs to determine which is more engaging to the customer according to some embodiments.

FIG. 7 illustrates a report on the number of users added to different segments according to some embodiments.

FIG. 8 illustrates components of an Internet of Things management system according to some embodiments.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled. It is understood that variations in configurations and combinations of components may be employed without departing from the scope of the present subject matter. The examples set forth herein are intended to be demonstrative and not a limiting or exhaustive depiction of variations.

Described herein is an Internet of Things device management platform (“platform”) that allows organizations to remotely monitor and configure a fleet of IOT devices. Various embodiments of the platform are described. One example platform is referred to herein as the Advos system. The present subject matter may be demonstrated by the Advos system, but the invention is not limited to that system. In the sections below, some software challenges presented by IOT and how the platform addresses these challenges are addressed. The platform architecture and how the platform may work for the retail environment are also discussed.

Devices in the Internet of Things typically carry out at least two functions: sensing and recording environmental conditions. In our example of the elevator, some device will sense and record your approach to the elevator. Machines in the Internet of Things will also be able to carry out instructions. The elevator reacts to your approach by ascending to your floor.

In most cases there will need to be some business rules between the machines that are sensing and the machines carrying out instructions. Staying with the elevator theme, we may want to only call the “best available” elevator to your floor. In order to make this decision we will need to know the state of all the elevators and run an algorithm that will determine the “best available”. In order to carry out these algorithms and for purposes of monitoring and configuring the devices in a system like this, some management software is needed. This is a purpose for which the platform was built.

### Demanding Data Requirements—Scalability

Referring again to the elevator example, we will need to determine the “best available” elevator to carry out the instructions. In order to do this we will need to know the current state of all of the elevators. This may include where they are, where they have just been, and if they are occupied. Because we cannot predict when you may get up from your chair and head down the hallway we will need to continuously have a picture of all of the elevators states. In order to do this we will need the elevators to periodically report on their conditions. We will then need to be able to collect and record these conditions for later use. For the sake of argument, assume we want each of the elevators to report on its present condition every 5 minutes. That would mean that every elevator would be making 288 data connections every day. And the elevator would be generating 288 data records every day. If you extend this out to every elevator in a bank of elevators, or everyone in a building, or a city, you can see how the data requirements of an IOT solution are intense. You could very quickly be handling millions of records every day.

These demanding data requirements favor a highly scalable solution for management. To this end, the platform is designed to use state of the art technology to create a highly scalable solution. Two main features of the platform of the present application that add to its scalability are the elastic cloud infrastructure and a BigTable implementation for data storage.

A specific implementation of the platform has been deployed on an App Engine which is Google's elastic cloud system; however, the present invention is not limited to the App Engine. The elastic cloud provides the platform with automatic scaling capabilities. First of all, this system is deployed in 5 different data centers located around the globe. The data between these data centers is automatically synced. This provides for a 100% uptime capability with full robust data recovery capabilities. Next, the system is running on two active and two passive virtual machines currently. This means that as the requirements for data connections increases the requests will be automatically load balanced to the running machines. If there is overflow the system will activate the passive machines to handle the extra flow. If our request load becomes too great for the initial four instances we can add as many additional instances we need to handle an almost unlimited volume of data connections.

### IOT is Evolving and Changing—Flexibility

The Internet of Things is just beginning to be rolled out and is changing rapidly. Various embodiments of the platform are designed to address the rapidly changing nature of the TOT landscape. A flexible data model abstracts the current use cases in to a more general model of the different kinds of things an TOT system will do. Below is a listing of some of the major components of the platform data model and what each of them represents, according to one embodiment:
Organization—This is a top level data object and represents a business entity. This is a company who is a subscriber to the platform system.
Site—An organization can have sites. A site is a physical location defined by an address. This would be a building or storefront.
Zone—A site can contain many zones. A zone defines a physical location within a site.
LocationCordinate—A zone is defined by one or many locationCordinates. These can represent a beacon id plus distance reading, a triad of GPS readings, a triad of WiFi triangulation readings or a number of other location based readings. Taken together they define the physical boundaries of a zone.
Device—A device is a machine which senses and records environmental conditions and or carries out instructions. The device can be owned by an organization, a site, a zone or a user.
DataLog—Stores data points provided by a device. Is owned by a device
User—A user in the system has one of the following roles. User, SiteAdmin, OrgAdmin, Superuser. Each role opens up a new set of API Endpoints.
Alarm—An object created by the datapoint received by a Device being outside the tolerances for that device. There is a background thread that will use the Alarm object to communicate an alarm condition via phone, SMS, email or URL
Vendor—A vendor defines an additional interested party to an alarm condition. Vendors are mapped to the organization or device type. They define an additional URL call that should be made in response to an alarm condition they also can define additional information to be sent with the alarm message in SMS or email.
Signal—A signal represents a configurable HTTP transaction to be performed in response to a call to the adAlert endpoint. They are mapped to the Organization and modified by information in the zone object. A signal can be configured to provide a device or zone id in a GET or the device or zone JSON object to a post. In various embodiments using social media sites, such as Facebook, there is also a Facebook type signal that will add a user to a custom audience through the Facebook Ads API. Other social media sites may be used without departing from the scope of the present subject matter.
Instruction—Instructions provide a method for devices to communicate with one another. An instruction is created by the createInstruction endpoint. It can be created by a device. It can be mapped to a specific device or to any device mapped to a particular site. The Instruction object contains a hashmap of key value pairs. Another device can then retrieve the instruction and execute some action.

This flexible data model can achieve many of the different use cases needed by a device management platform in the Internet of Things. Using the elevator example again we will see how this data model works. Assume your phone is mapped as a device in our system. As you walk down the hall your phone will pick up a beacon mapped as a zone in the system. It records the data and creates a set of instructions. The instruction object is picked up by a second device attached to the elevator. The device attached to the elevator knows to move the elevator to the floor you are on. On its way to your floor the elevator device detects a strange noise in the motor. This triggers an alarm condition for the elevator device. The building manager is alerted via email through the Alarm object. A vendor who is mapped to the elevator device is alerted via HTTP post. This post creates a work order in the elevator repair vendors workflow system. This work order sends a repairman out to the site to repair the bad motor.

### Every System Will be Connected—Extensibility

In a hyper connected future, every system may communicate with other systems, and systems which will not integrate will be devalued. To this end the Advos platform system was built to be highly extensible. For example, the Advos platform is a Restful web service. All of the data objects and business rules can be reached using a standard set of HTTP requests. Many systems stop here with extensibility but with the Advos platform, it is taken one step further. By using Signals, the platform is able to provide triggers in other systems. These configurable Signals can push certain key information points in to other systems. Currently we can provide another system with a trigger of system events containing information about the device or the zone. Using this information and the API, other systems can quickly access any information in the platform system. We can also alert another system through the vendor concept. A vendor is a party interested in alarm conditions on a particular device or group of devices. If an alarm condition exists in a device, the vendor's system of choice can be alerted. Finally we provide information on system events in human readable form through the Alarm objects. Alarms can notify people via SMS, email or voice to an alarm condition.

The API coupled with the numerous triggers provided by Alarm, Vendor and Signal create a highly extensible solution. The platform may be integrated with a variety of other systems to help create a hyper connected Internet of Things.

### System Architecture

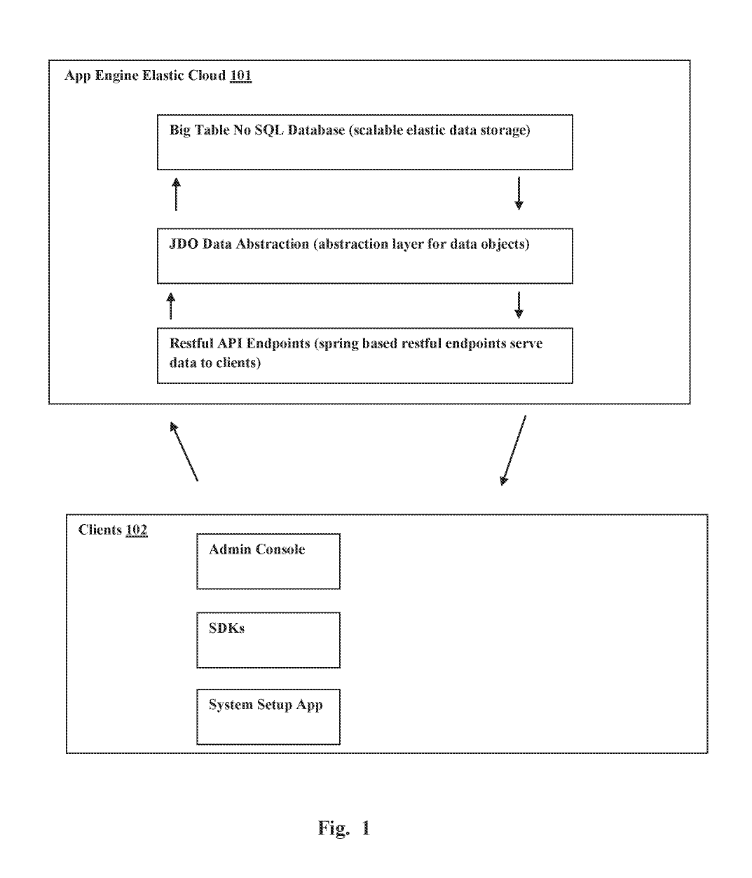

The Advos platform may include components in various embodiments as illustrated by FIG. 1 which depicts a services layer 101 executed by the App Engine interacting with the clients 102. A restful service layer (the services), an admin console, SDKs for both the IOS and Android platforms (IOS and Android are but some examples, other platforms may be used without departing from the scope of the present subject matter) and a system setup application for both IOS and Android, for example. The platform has a service-oriented architecture, which means that all of the other main components are clients of the services. Each of these components is discussed further below.

### The Services

The services exist as a restful service layer. As a restful service layer they use the standard http protocol methods GET, POST, UPDATE, and DELETE. Headers are used for authentication. The data transfer to the POST, UPDATE calls and return data from the services is in the JSON format. There are CRUD (Create, Read, Update, Delete) methods for all of the core data objects in the system. In addition there are a few additional endpoints such as GetZonesBySiteID which will carry out some business logic to retrieve information which the clients can consume.

In general the services handle the data and carry out system wide business rules and functions. The services maintain all of the data records, enforce roles and authentication, execute on alarms and execute signals. The services are deployed on the Google App Engine elastic cloud and can be reached at two endpoints.

The services contain an API endpoint layer built using Spring. There is a JDO data abstraction layer, which abstracts our business objects from the database implementation. This abstraction layer allows us to change the database without having to rewrite all of our data parsing logic. Finally there is a Big Table No SQL database in use. This database allows for a fast scalable data storage system. The Graphic illustrated in FIG. 1 shows each layer in the services.

### The Admin Console

The admin console is a client of the services and provides the functionality to create, read, edit and delete all of the objects in the database. The admin console also is deployed to the Google App Engine elastic cloud. The admin console adheres to all of the roles and authentication rules enforced by the services. In addition to the basic CRUD operations the admin console displays a dashboard of relevant information. This dashboard may change depending on the specific use case.

### The SDKs

A SDK or Software Development Kit is a distributable piece of software meant to be implemented into another application. In this case the SDK refers to binary Android and IOS libraries that customers can use to easily “borrow” the functionality of the platform system. The SDK will be implemented in to existing or new customer applications. Their applications will then have all of the functionality of the platform. The SDK provides two major functions. It manages the Bluetooth connections with our beacons and it provides an easily consumable method of getting data from the services. The SDK for each platform exposes a number of interfaces the customer can use to produce unique platform capable applications.

### The System Setup Application

The System Setup Application is an application developed using the SDKs. This application for both IOS and Android is specific to the Advos for Retail Application. Other platforms may use different operating systems. It allows a store manager to setup and configure the zones for his site. He can mark each zone with a beacon and add location coordinates to the zone based on the beacons unique ID and signal strength readings.

### Platform for Retail

The platform for retail was designed to be a flexible IOT platform. In short, the platform helps retailers deliver relevant information, offers, and incentives to customers in their store. The information captured from customers is then passed to your various business management platforms to make more intelligent business decisions. As a result, customers can have more streamlined shopping experiences that are personalized to their interests. The platform for retail system may include a number of components. In one example, there are two applications, beacons and smart tags.

### Applications for Retail

### The Mobile Shopper Application

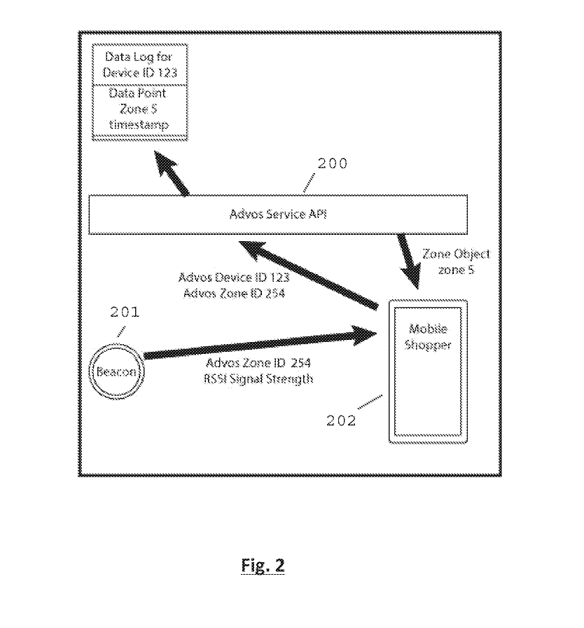

The Mobile Shopper Application is an application to be used by customers while they are in the physical store. The application may be developed according to the retailer's individual brand. The SDK has a programming interface that will turn an existing app in to a Mobile Shopper application for the purposes of our system. The Mobile Shopper application will sense and record the Beacon ids it encounters as the device moves through the store. The graphic in FIG. 2 shows a typical interaction between the services layer 200, beacon 201, and the Mobile Shopper device 202.

The beacon broadcasts a unique ID out. This ID along with a signal strength reading is picked up by the platform SDK in the retail application. This ID is sent to the server along with a unique ID for the Mobile Shopper device. If the zone ID is recognized and the signal strength is within the specified tuning number of the zone in the application services the transaction is logged and a zone object is returned to the Mobile Shopper device. The transaction is logged to the Mobile Shopper's Data Log along with an identifier of the zone and a timestamp when the transaction took place. This is called a “passive transaction” with a beacon. It is a passive transaction because the shopper does not actually take any action to make this transaction happen.

A second kind of interaction the Mobile Shopper application can have with a beacon in the store is an active transaction. In this case the beacon is referred to as a smart tag. Essentially the data interaction is the same as with a passive transaction. The difference lies in how the user interacts with the zone information returned from the platform services. First of all the interaction is initiated by the user. The retailer's application presents the user with a button which, when pushed, will trigger the SDK to read any beacon in very close proximity. The Zone data returned from the services will contain a Zone Payload object. The Zone Payload contains instructions that the retail app can use to trigger some action in their app. The Zone Payload is completely configurable through the admin console. The Zone Payload could contain information that would instruct the retailers application to open another application, download product information, like a product on Facebook or any number of other interesting user interactions.

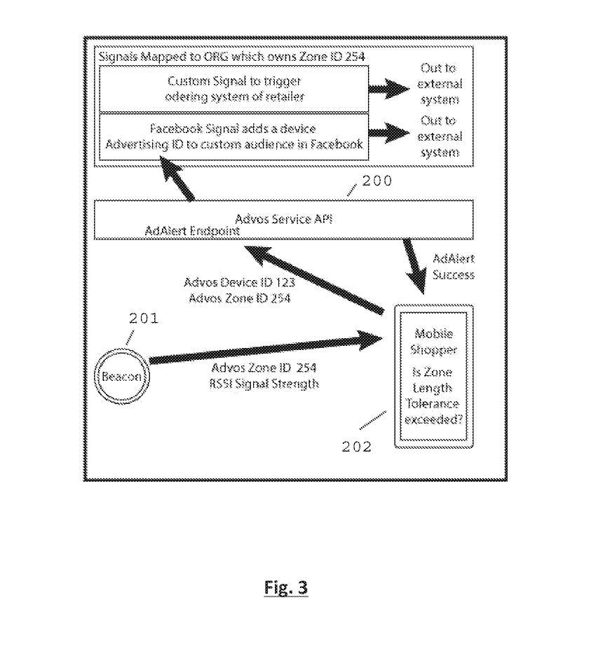

The third kind of interaction happens when the Mobile Shopper stays in a Zone for longer than the specified Zone Length Tolerance. Zone Length Tolerance is a number stored in the Zone object of the platform system. It represents a time beyond which we should trigger a series of Signals in the services. The Signals will act as triggers for other systems to act upon. For example, Signals are triggered through a call to the AdAlert endpoint of the Advos services. The SDK for Mobile Shopper will trigger this endpoint automatically whenever the Zone Length Tolerance is exceeded by a Mobile Shopper device. FIG. 3 is a graphic showing this interaction between the services layer 200, beacon 201, and the Mobile Shopper device 202.

The Signals are created and configured by the retail organization. They each represent a call to an external data API. The custom signal can be configured to make a call to any external system. The Social Media Signals are preconfigured to add a device Advertising ID to a custom audience for that particular Zone.

The fourth kind of interaction possible from the Mobile Shopper application is that of creating instructions. In this Use case the retailer would present a button to the user that reads “Get Assistance”. This button would trigger the SDK to make a call to the Create Instructions endpoint in the platform services. The instructions would then be consumed by the Guest Assist application. This interaction is pictured below in the Guest Assist section.

### The Guest Assist Application

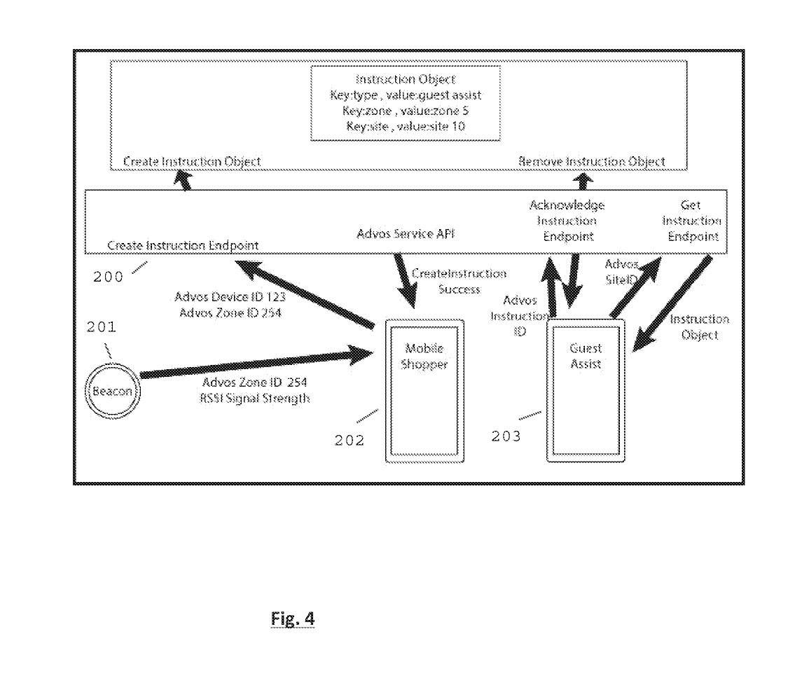

The Guest Assist Application is an application to be used by retail employees while they are in the physical store. The app will be developed according to the retailer's individual brand. For example Target could have an application for team members to use while they are on duty in the store. The SDK has a programming interface that will turn an existing application in to a Guest Assist Application for the purposes of our system. The Guest Assist application will poll the platform services for Instruction objects and display the appropriate messages to team members. The interaction between the Mobile Shopper app 202, the Guest Assist application 203, beacon 201 and the platform services 200 are pictured in FIG. 4 according to one embodiment relating to Advos.

The SDK in the Mobile Shopper application detects the beacon ID. It sends this ID along with its own Device ID to the Create Instruction endpoint of the platform services. This creates an instruction object in the database that contains the site, which the Zone ID is attached to. The SDK in the Guest Assist application calls the Get Instruction endpoint of the platform Services passing the SiteID, which it is mapped to. If any instructions exist for this site these Instruction objects are sent back to the Guest Assist application. The SDK will pass this list back to the Guest Assist application. The application will display the list showing all customers in the store which are currently in need of help. The application will also show the name of the zone the customer is in. When the employee goes to help the customer they will press an acknowledge button on their device. This action will trigger the SDK to call the Acknowledge Instruction endpoint of the platform services. This will remove the Instruction object from the datastore. The next time a Guest Assist app calls for instructions the one already acknowledged will be gone from the list.

### What the Platform Allows the Retailer to do

### In-Store Analytics

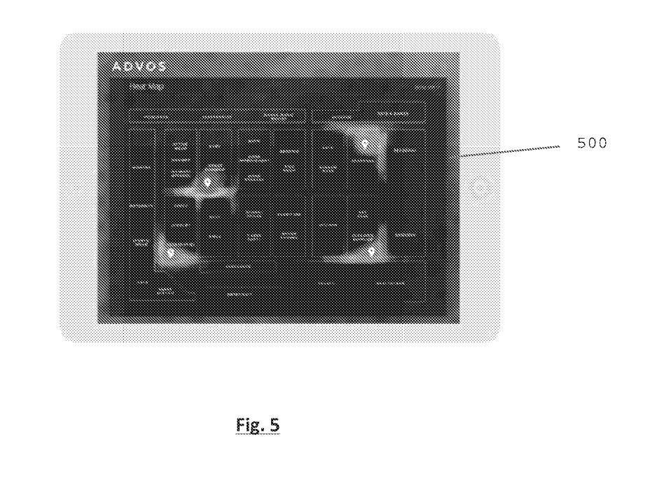

Each interaction between the Mobile Shopper application and the beacon is recorded. This allows us to display a rich set of analytics regarding how customers are interacting with stores. At the site level we can display a heatmap of the store showing how many Mobile Shopper devices are interacting with each zone. An example of a heatmap 500 is shown in FIG. 5. With this data we can determine the best performing end caps based on traffic patterns. Retailers can then monetize that space with vendors who are willing to pay for the prime real estate. This idea can enhance the profitability of brick and mortar retail like never before.

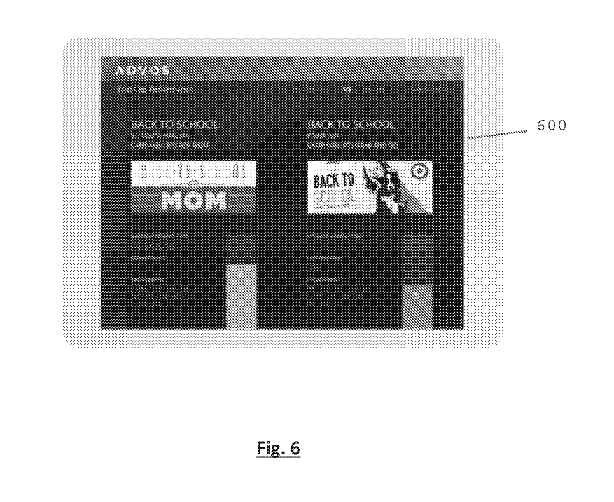

By counting the number of AdAlert interactions we can measure the level of customer engagement with specific sections of the store. We can use this information to set up A/B testing scenarios with in store creative. We can test two similar endcap designs to determine which is more engaging to the customer. An example display 600 is shown in FIG. 6. It would be valuable would it be to know what creative will perform the best across thousands of brick and mortar stores.

### Custom Audience Building for Marketing

There is a great drive on the social media platforms to push marketing down to the individual level. By leveraging the data in social media it is possible to present marketing messaging that is tailored to the individual. Through recent mergers and acquisitions in the social media space it is possible to present the messages to individuals across the web and across the app sphere. In order to facilitate this kind of marketing the social media platforms are using the concept of custom audiences. These are essentially lists of people for whom you can build a campaign around. For example a custom audience could be made up of women in Minneapolis between 35 and 37 who have shown an interest in marathons. Once defined you can build imaging and messaging specifically for this group and present them highly personalized marketing across the web and apps.

Custom audiences are key to the delivery of these messages. The platform of the present subject matter will allow retailers to add a new dimension to their custom audiences. With such a platform it is possible to define a custom audience of women in Minneapolis between 35 and 37 who have shown an interest in marathons who have shown an interest in the shoe department at Target. The introduction of real world interactions in to the creation of custom audiences is unique to the platform.

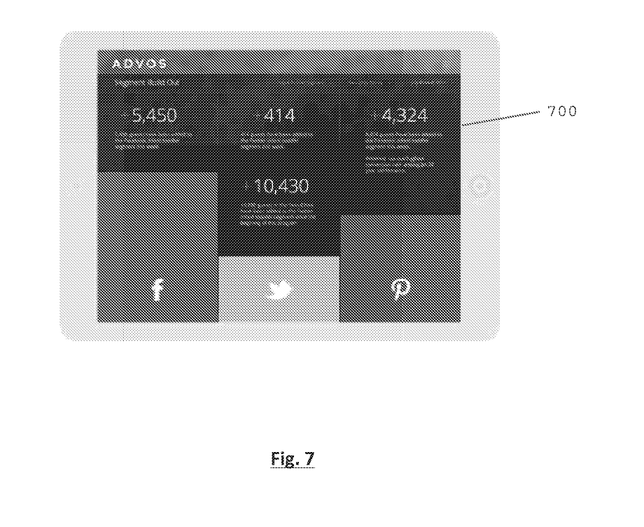

It is accomplished through the concept of Signals. When a Mobile Shopper application triggers an Ad Alert call we will execute a series of Signals defined by the organization. In the case of the Facebook Signal, we have built an integration to the ads API at Facebook. This integration allows us to add a Device Advertising ID to a custom audience in Facebook. The custom audience we will add to is determined by the Zone where the interaction happened and is configurable by the Organization Admin. We can then report on the number of users added to different segments. An example display 700 is shown in FIG. 7. This presents the retailer another great opportunity to engage with their customers. They could also monetize the audiences they create by allowing vendors to build marketing campaigns on their rich data sets for a fee.

### Smart Tags

Smart tags are an active type interaction with a beacon. In this use case the beacon is encased in some kind of enclosure that lets people visually know that they can interact with it. The case could take any shape needed, including, but not limited to the forms of a pinterest pin, a Facebook like button, a map pin, an info circle and an offer star. These tags can be placed around a store and will allow the Mobile Shopper app to interact with some digital content. This happens in the Mobile Shopper app when the app is placed near a smart tag and the user presses a button. This button press will trigger the SDK to get the ID from the nearby beacon and then retrieve the Zone object from the Advos services. The Zone object contains a list of key value pairs collectively known as Zone Payload. The SDK will then deliver the Zone object containing the Zone Payload to the retailers app. The app can then use the information stored in the Zone Payload to take some action on the users behalf. This action could really be anything but some common use cases would be retrieving data from a specified URL, launching another app on the users device or navigating to some web content. The Zone Payload is configurable for the Zone in the admin console by the Organization Admin.

### Example Applications

Most information about how people are moving in space is lost as soon as they pass. Businesses have no easy low cost way to collect information about how customers are engaging with their businesses in physical space. Furthermore, once a customer has passed by the business has no way to continue the conversation started in their physical space. The Advos system solves these problems by introducing a new way to engage customers in physical space and new communication pathways to continue the conversation. Business can now provide rich personalized messages to their customers based on where and how the customer engages with their brick and mortar locations. By capturing information about how people are engaging in physical space we can provide rich data sets that can help the business evolve how they engage their customers. Through our connections with the social media ad platforms we allow the business to build rich user clusters that can then be targeted with further messaging. In this way the business can continue a conversation with their customers started in physical space. These customer clusters can also be used to profile and generate new prospect lists based on the knowledge they gained about their existing customers.

To illustrate the features of the Advos platform and how it changes what people do specifically, described below are how the different aspects of how the system behaves in a number of example applications according to one embodiment. Short descriptions of each application are given below.

### Building Mechanical Maintenance TOT Application

This is an application where the mechanicals of a building can be monitored remotely. The Advos system would connect various sensors on the mechanical equipment in the building. Each sensor would be given a trigger which would describe when its readings are out of range. When the sensors are out of range the system would trigger communications with personnel and other systems about a potential problem. This will make the maintenance of mechanical equipment more efficient by heading off small problems and also informing the maintenance provider of the nature of the problem. This will allow for more effective scheduling and parts management.

### Restaurant Equipment TOT Application

This application has three parts. The first part is an application where the mechanicals of a restaurant can be monitored remotely. The Advos system would connect various sensors on the equipment in the restaurant. Each sensor would be given a trigger which would describe when its readings are out of range. When the sensors are out of range the system would trigger communications with personnel and other systems about a potential problem. This will make the maintenance of equipment more efficient by heading off small problems and also informing the maintenance provider of the nature of the problem. This will allow for more effective scheduling and parts management. The second part is a new pathway for communication with their customers. When a customer enters the brick and mortar location she is likely carrying a mobile device. Through the Advos system the business can send rich personalized message to the customer based on who they are and how they interact with the business. Advos will then capture the information about that customer interaction and provide insights to the business. The system provides data about how customers interact with the physical location. Because of our connection to social media we can also provide rich insights in to who they are. We will also build customer clusters which can be re targeted to continue the conversation after they leave the location. The third part can do basically the same as the second but with a focus on employees. With the Advos system the business can more effectively engage their employees by serving personalized messaging and recording their movements. The customer experience can also be connected to the employee experience through Advos. This will allow the employees to be more responsive to the customers.

### Retail Marketing Application

This application has three parts. The first part is a new pathway for communication with their customers. When a customer enters the brick and mortar location she is likely carrying a mobile device. Through the Advos system the business can send rich personalized message to the customer based on who they are and how they interact with the business. Advos will then capture the information about that customer interaction and provide insights to the business. The system provides data about how customers interact with the physical location. Because of our connection to social media we can also provide rich insights in to who they are. We will also build customer clusters which can be re targeted to continue the conversation after they leave the location. The second part can do basically the same as the second but with a focus on employees. With the Advos system the business can more effectively engage their employees by serving personalized messaging and recording their movements. The customer experience can also be connected to the employee experience through the Advos system. This will allow the employees to be more responsive to the customers.

### Home Builder Application

This application has three parts. The first part is an application where the mechanicals of a customers home can be monitored remotely. The Advos system would connect various sensors on the equipment in the home. Each sensor would be given a trigger which would describe when its readings are out of range. When the sensors are out of range the system would trigger communications with the homeowner, builder personnel and other systems about a potential problem. This will make the maintenance of equipment more efficient by heading off small problems and also informing the maintenance provider of the nature of the problem. This will allow for more effective scheduling and parts management.

The second part is a new pathway for communication with their customers. When a customer enters a model home she is likely carrying a mobile device. Through the Advos system the home builder can send rich personalized message to the customer based on who they are and how they interact with the business. For example the builder could construct a message about countertop options when a buyer enters the kitchen. Advos will then capture the information about that customer interaction and provide insights to the business. The system provides data about how customers interact with the physical location. Because of our connection to social media we can also provide rich insights into who they are. We will also build customer clusters which can be re targeted to continue the conversation after they leave the location.

The third part will use the Advos system to connect the customer experience with and experience for the sales professional. This would allow the buyer to trigger a question or comment which could be received by all sales professionals in the home instantly. This will make the sales professional more responsive to the customer.

### Employee Engagement Application

In this application, the business will use the Advos system but focus on employees. With the Advos system, the business can more effectively engage their employees by serving personalized messaging and recording their movements. The customer experience can also be connected to the employee experience through Advos. This will allow the employees to be more responsive to the customers.

### Manufacturing/Industrial Application

This is an application where the mechanicals of a building can be monitored remotely. The Advos system would connect various sensors on the mechanical equipment in the building. Each sensor would be given a trigger which would describe when its readings are out of range. When the sensors are out of range the system would trigger communications with personnel and other systems about a potential problem. This will make the maintenance of mechanical equipment more efficient by heading off small problems and also informing the maintenance provider of the nature of the problem. This will allow for more effective scheduling and parts management.

The manufacturer can also use the Advos system to create and monitor safety inspection routes and ensure employee safety. By monitoring employee movements through the facility an employer can for example know when someone has entered an area they should not or account for all personnel in the case of emergency.

### Sponsored Smart Home Application

This application has three parts. The first part is an application where the mechanicals of a customers home can be monitored remotely. The Advos system would connect various sensors on the equipment in the home. Each sensor would be given a trigger which would describe when its readings are out of range. When the sensors are out of range the system would trigger communications with the homeowner, builder personnel and other systems about a potential problem. This will make the maintenance of equipment more efficient by heading off small problems and also informing the maintenance provider of the nature of the problem. This will allow for more effective scheduling and parts management.

### Billboard Advertising Application

This application presents a new pathway for communication with their customers. When a customer enters the brick and mortar location she is likely carrying a mobile device. Through the Advos system the business can send rich personalized message to the customer based on who they are and how they interact with the business. Advos will then capture the information about that customer interaction and provide insights to the business. The system provides data about how customers interact with the physical location. Using connections to social media can also provide rich insights as to who they are. Customer clusters may be built which can be re-targeted to continue the conversation after the customers leave the location.

### Hospitality Application

This application has three parts. The first part is an application where the mechanicals of a restaurant can be monitored remotely. The Advos system would connect various sensors on the equipment in the restaurant. Each sensor would be given a trigger which would describe when its readings are out of range. When the sensors are out of range the system would trigger communications with personnel and other systems about a potential problem. This will make the maintenance of equipment more efficient by heading off small problems and also informing the maintenance provider of the nature of the problem. This will allow for more effective scheduling and parts management. The second part is a new pathway for communication with their customers. When a customer enters the brick and mortar location she is likely carrying a mobile device. Through the Advos system the business can send rich personalized message to the customer based on who they are and how they interact with the business. Advos will then capture the information about that customer interaction and provide insights to the business. The system provides data about how customers interact with the physical location. Because of our connection to social media we can also provide rich insights in to who they are. We will also build customer clusters which can be re targeted to continue the conversation after they leave the location. The third part can do basically the same as the second but with a focus on employees. With the Advos system the business can more effectively engage their employees by serving personalized messaging and recording their movements. The customer experience can also be connected to the employee experience through Advos. This will allow the employees to be more responsive to the customers.

### Theme Park Application

This application has three parts. The first part is an application where the mechanicals of a restaurant can be monitored remotely. The Advos system would connect various sensors on the equipment in the restaurant. Each sensor would be given a trigger which would describe when its readings are out of range. When the sensors are out of range the system would trigger communications with personnel and other systems about a potential problem. This will make the maintenance of equipment more efficient by heading off small problems and also informing the maintenance provider of the nature of the problem. This will allow for more effective scheduling and parts management. The second part is a new pathway for communication with their customers. When a customer enters the brick and mortar location she is likely carrying a mobile device. Through the Advos system the business can send rich personalized message to the customer based on who they are and how they interact with the business. Advos will then capture the information about that customer interaction and provide insights to the business. The system provides data about how customers interact with the physical location. Because of our connection to social media we can also provide rich insights in to who they are. We will also build customer clusters which can be re targeted to continue the conversation after they leave the location. The third part can do basically the same as the second but with a focus on employees. With the Advos system the business can more effectively engage their employees by serving personalized messaging and recording their movements. The customer experience can also be connected to the employee experience through Advos. This will allow the employees to be more responsive to the customers.

### The Data Model

The following sections provide an overview of abstraction and how the data model mirrors the interactions of TOT to create a cohesive model that can be used for a variety of TOT applications. TOT is in a sense is the merging of the physical and digital worlds. In order for this merge to occur we must create digital representations of physical things and physical representations of digital things. The Advos system provides a data model which represents and stores these relationships in a robust and flexible way. Below are descriptions of a few key features of an example data model for Advos according to one embodiment and how they work in a number of different IOT applications.

### The Org-Site-Zone Relationship

What is an Org? The Org is a container which binds together a group of people, devices, sites and zones. It defines how the other items are related to each other and who is able to interact with each of the other items. What is a Site? A Site represents a physical location. It can be defined by an address or by a more generalized abstract definition such as region. A Site is always owned by an Org. A Site may own one or many Zones and Devices. What is a Zone? A Zone represents a location is space. The location in space that is defined by a zone is not defined by an address but rather by a group of data points known as LocationCoordinate. A location coordinate group can store information from a variety of location schemas. It can describe a place based on GPS, BLE Beacon, NFC, WIFI Triangulation or any other system that can create an electronic marker in space. A Zone can be owned by an Org or a Site. A Zone can own Devices. In some cases the Zone can also contain messaging that a person would see when they come in contact with the zone. Descriptions of how these flexible relationships and objects are used in example applications are given below.

### Building Mechanical Maintenance IOT Application

In this application, the Org is set up for the building maintenance company. A Site could represent one bank of escalators. While they do have an address in terms of the building several sites may be located in the same building. Each Zone represents a part of the escalator bank for example the “Handrail Zone” represents the handrails of the escalator bank. The Zone contains devices which monitor and report on the conditions within the zone in this case they monitor the vibration level of the handrails.

### Restaurant Equipment TOT Application

In this application the Org is set up for the restaurant chain. Each restaurant in the chain is represented by a site. The Zones represent the different areas of the restaurant one zone for the bar area and a different one for the kitchen for example. The zones can be defined by location coordinate groups. The zones can interact with customers and employees through mobile devices. The zones will also contain devices which will monitor the conditions of different equipment. For example, the steam tables will have temperature monitors which will record temperatures and trigger alarms when the temperature falls out of safe ranges. All of the equipment in the restaurant will be connected with sensors to ensure proper operation.

### Retail Marketing Application

In the marketing application the Org can be the retailer, the OEM or the display manufacturer. If the Org is the retailer the site is a physical location of each store and the zone represents each area or point of interest in the store. If the Org is the OEM then the Site would represent each retail location where their product is sold and the zone is the place in the store where there product is sold. If the Org is the display manufacturer the site would be each retail location which contains their displays and the zone would represent each display within the site.

### Home Builder Application

In the home builder application the Org represents the home builder. The Site represents each house and the zones define different areas of the house. One zone may be the kitchen. The zone is defined by a group of location coordinate objects and each zone contains devices which can monitor the conditions of the area.

### Employee Engagement Application

In this application the Org will be the customer of the employee engagement application. The Sites will represent each of their locations and the zones will be areas within the location. Employees will be presented with information depending on their job code and interactions with the zones.

### Manufacturing/Industrial Application

In this application, the Org would be the manufacturing company. The Site would be the physical location of each plant. The zones would represent areas within the plant. Employees would interact with the zones while they make their rounds to ensure proper coverage and safety standards. Other zones would represent pieces equipment and would contain devices that would monitor the conditions of the equipment.

### Sponsored Smart Home Application

In the sponsored smart home application the Org would be the sponsor for example the home insurance provider. The Sites would represent the homes of their customers. The zones would represent areas in the home. The zones contain devices which would monitor the environment in the zone.

### Billboard Advertising Application

In the billboard advertising application the Org would be the company which owns the billboards. The sites would be a more abstract grouping defining an area for example the site would be lower manhattan. Each site would have a number of zones representing the advertising reach of that billboard. These would be defined by a group of location coordinates.

### Hospitality Application

In a hospitality application the Org would be the owner of the hotel/convention center. The site would be each building and zones would define areas within each site.

### Theme Park Application

In a theme park application, the Org would be the owner of the park. The site would represent the physical location for each park or each attraction in the park. Zones would be defined to describe both the broad geo-location of each site and also areas or points of interest within each site using groups of location coordinates.

### The Role of a Device

What is a device? A device is an electronic piece of equipment capable of sensing and recording data, triggering alarms, carrying out instructions, and placing instructions. A device may carry out one, two, three or all of these basic functions. In order for a device to sense data it must have some form of data detection equipment. This could take the form of any kind of electronic sensor or a user input such as a button. In order for the device to record data or trigger alarms, carry out instructions or place instructions it must be capable of making a data connection to the service layer. In order to carry out instructions a device may be capable of making a change to its own memory store, displaying a message, or actuating a physical device. Descriptions of the roles of devices in example applications are given below.

### Building Mechanical Maintenance TOT Application

The devices in the escalator maintenance TOT application would be capable of sensing the conditions of a particular piece of the escalator bank. For example there would be a device which will sense the temperature and vibration level of each motor. The device would then use a shared data connection or its own to record this state to the service layer. If the level of temperature or vibration sensed by the device were outside the defined tolerances for that device the device would use a shared data connection or its own to trigger an alarm.

### Restaurant Equipment TOT Application

In the Restaurant application there would be three kinds of devices. One device called the Mobile Shopper exists as an sdk in a mobile application. This device senses electronic signals and asks the server if the signals match an existing location coordinate group. When a match is found the device uses its own data connection to record the interaction. When an interaction is outside the defined tolerances for that zone the device raises an alarm with the services. It also displays a customizable message on the device in reaction to the alarm. This device also uses its own data connection to create instructions. The second kind of device which operates in this application is the Mobile Helper device. This device exists as an sdk on a mobile device. This device senses electronic signals and asks the server if the signals match an existing location coordinate group. When a match is found the device uses its own data connection to record the interaction. When an interaction is outside the defined tolerances for that zone the device raises an alarm with the services. This device also uses its own data connection to carry out instructions. It receives the instructions and as a result displays a message on the mobile device. The third kind of device in this application would be capable of sensing the conditions of a particular piece of the equipment in the restaurant. For example, there would be a device which will sense the temperature of a steam table in the kitchen. The device would then use a shared data connection or its own to record this state to the service layer. If the level of temperature sensed by the device were outside the defined tolerances for that device, the device would use a shared data connection or its own to trigger an alarm.

### Retail Marketing Application

In the Retail Marketing application there may be two kinds of devices. One device called the Mobile Shopper exists as an sdk in a mobile application. This device senses electronic signals and asks the server if the signals match an existing location coordinate group. When a match is found the device uses its own data connection to record the interaction. When an interaction is outside the defined tolerances for that zone the device raises an alarm with the services. It also displays a customizable message on the device in reaction to the alarm. This device also uses its own data connection to create instructions. The second kind of device which operates in this application is the Mobile Helper device. This device exists as an sdk on a mobile device. This device senses electronic signals and asks the server if the signals match an existing location coordinate group. When a match is found the device uses its own data connection to record the interaction. When an interaction is outside the defined tolerances for that zone the device raises an alarm with the services. This device also uses its own data connection to carry out instructions. It receives the instructions and as a result displays a message on the mobile device.

### Home Builder Application

In the Home Builder application there may be three kinds of devices. One device called the Mobile Shopper exists as an sdk in a mobile application. This device senses electronic signals and asks the server if the signals match an existing location coordinate group. When a match is found the device uses its own data connection to record the interaction. When an interaction is outside the defined tolerances for that zone the device raises an alarm with the services. It also displays a customizable message on the device in reaction to the alarm. This device also uses its own data connection to create instructions. The second kind of device which operates in this application is the Mobile Helper device. This device exists as an sdk on a mobile device. This device senses electronic signals and asks the server if the signals match an existing location coordinate group. When a match is found the device uses its own data connection to record the interaction. When an interaction is outside the defined tolerances for that zone the device raises an alarm with the services. This device also uses its own data connection to carry out instructions. It receives the instructions and as a result displays a message on the mobile device. The third kind of device in this application would be capable of sensing the conditions of a particular piece of the equipment in the home. For example there would be a device which will sense the existence of water under the water heater in the basement. The device would then use a shared data connection or its own to record this state to the service layer. If water is detected the device would use a shared data connection or its own to trigger an alarm.

### Employee Engagement Application

In the employee engagement application, the device may be the Mobile Helper device. This device exists as an sdk on a mobile device. This device senses electronic signals and asks the server if the signals match an existing location coordinate group. When a match is found the device uses its own data connection to record the interaction. When an interaction is outside the defined tolerances for that zone the device raises an alarm with the services. It also displays a customizable message on the device in reaction to the alarm. This device also uses its own data connection to carry out instructions. It receives the instructions and as a result displays a message on the mobile device.

### Manufacturing/Industrial Application

In the manufacturing application there may be two kinds of devices. The first device is the Mobile Helper device. This device exists as an sdk on a mobile device. This device senses electronic signals and asks the server if the signals match an existing location coordinate group. When a match is found the device uses its own data connection to record the interaction. When an interaction is outside the defined tolerances for that zone the device raises an alarm with the services. This device also uses its own data connection to carry out instructions. It receives the instructions and as a result displays a message on the mobile device. The second kind of device in this application would be capable of sensing the conditions of a particular piece of the equipment in the plant. For example there would be a device which will sense the temperature of a machine on the floor. The device would then use a shared data connection or its own to record this state to the service layer. If the level of temperature sensed by the device were outside the defined tolerances for that device the device would use a shared data connection or its own to trigger an alarm.

### Sponsored Smart Home Application

In the sponsored smart home application, there may be three kinds of devices. One device will exists as an sdk in a mobile application. This device would use its own data connection to carry out instructions. It receives the instructions and as a result displays a message on the mobile device. This would take the form of a dashboard app for the homeowner to view the conditions in his home. The app would also be capable of creating instructions for the other devices in the home. The second kind of device in this application would be capable of sensing the conditions of a particular piece of the equipment in the home. For example there would be a device which will sense the existence of water under the water heater in the basement. The device would then use a shared data connection or its own to record this state to the service layer. If water were detected the device would use a shared data connection or its own to trigger an alarm. The third kind of device in this application would be capable of carrying out instructions. It would then use a shared data connection or its own to retrieve instructions from the service and would use these instructions to actuate some physical action. For example a connected valve device may receive instructions that tell it to close in response to water detection under the water heater.

### Billboard Advertising Application

In the Billboard application the device called the Mobile Shopper exists as an sdk in a mobile application. This device senses electronic signals and asks the server if the signals match an existing location coordinate group. When a match is found the device uses its own data connection to record the interaction. When an interaction is outside the defined tolerances for that zone the device raises an alarm with the services. It also displays a customizable message on the device in reaction to the alarm.

### Hospitality Application

In the Hospitality application there would be three kinds of devices. One device called the Mobile Shopper exists as an sdk in a mobile application. This device senses electronic signals and asks the server if the signals match an existing location coordinate group. When a match is found the device uses its own data connection to record the interaction. When an interaction is outside the defined tolerances for that zone the device raises an alarm with the services. It also displays a customizable message on the device in reaction to the alarm. This device also uses its own data connection to create instructions. The second kind of device which operates in this application is the Mobile Helper device. This device exists as an sdk on a mobile device. This device senses electronic signals and asks the server if the signals match an existing location coordinate group. When a match is found the device uses its own data connection to record the interaction. When an interaction is outside the defined tolerances for that zone the device raises an alarm with the services. This device also uses its own data connection to carry out instructions. It receives the instructions and as a result displays a message on the mobile device. The third kind of device in this application would be capable of sensing the conditions of a particular piece of the equipment in the hotel. For example there would be a device which will sense the temperature of a steam table in the kitchen. The device would then use a shared data connection or its own to record this state to the service layer. If the level of temperature sensed by the device were outside the defined tolerances for that device the device would use a shared data connection or its own to trigger an alarm.

### Theme Park Application

In the Theme park application there may be three kinds of devices. One device called the Mobile Shopper exists as an sdk in a mobile application. This device senses electronic signals and asks the server if the signals match an existing location coordinate group. When a match is found the device uses its own data connection to record the interaction. When an interaction is outside the defined tolerances for that zone the device raises an alarm with the services. It also displays a customizable message on the device in reaction to the alarm. This device also uses its own data connection to create instructions. The second kind of device which operates in this application is the Mobile Helper device. This device exists as an sdk on a mobile device. This device senses electronic signals and asks the server if the signals match an existing location coordinate group. When a match is found the device uses its own data connection to record the interaction. When an interaction is outside the defined tolerances for that zone the device raises an alarm with the services. This device also uses its own data connection to carry out instructions. It receives the instructions and as a result displays a message on the mobile device. The third kind of device in this application would be capable of sensing the conditions of a particular piece of the equipment in the theme park. For example there would be a device which will sense the temperature of a steam table in the restaurant. The device would then use a shared data connection or its own to record this state to the service layer. If the level of temperature sensed by the device were outside the defined tolerances for that device the device would use a shared data connection or its own to trigger an alarm.

### The Ownership of Devices

What is possible and why is this important? A device can be owned by a user, an org, a site or a zone. Further a device can be owned by a user but mapped to an org or site. This configuration gives us a rich structure to help define the way devices will interact with people and each other. Descriptions of the ownership of devices in the context of example applications are given below.

### Escalator Maintenance TOT Application

In this application the devices are mapped to the zone. The site represents a bank of escalators the zone represents a part of the bank. This configuration allows us to report on the conditions of a cohesive part of the escalator. For example the handrail may have a motor on the top and another on the bottom. By creating a zone for handrail we are able to report on the condition of the handrail as a whole. Also it allows us to draw inferences about possible conditions by combining data from the two motors. For example we can compare the temperature of the motor on the top to the motor on the bottom to infer the condition of the whole zone (in this case handrail system).

### Restaurant Equipment TOT Application

In this application there are three devices. First the Mobile shopper device is owned by a user and mapped to an org. The user is the customer who is holding the app containing the mobile shopper sdk. The Org is the restaurant chain. This allows the restaurant visibility into how customers are using their services. Because the device is mapped to a user (customer) the restaurant can ask questions like “when is the last time this customer was in?”, “how often does this customer come in?”. The second device is the Mobile Helper device. This device is owned by a user (in this case an employee) but is mapped to a site. This allows us to communicate with all employees of a particular site at once. It also allows those employees to share data and interact on the same pieces of data. For example, when a mobile shopper creates an instruction object (this instruction object would indicate a need for another drink) the instruction can be picked up by every device mapped to the site. So a message would display on every mobile device mapped to that site. Then when an employee has taken care of the request she can acknowledge the instruction this action would remove the message from all the other devices mapped to the site. The third kind of device would sense and report environmental data. This device is owned by the zone. This configuration allows us to report on the conditions of a cohesive part of the restaurant. For example the steam table may have three different steam bays. By creating a zone for steam table we are able to report on the condition of the steam table as a whole. Also it allows us to draw inferences about possible conditions by combining data from the three bays. For example we can compare the temperature of the three bays to infer the condition of the whole zone (in this case steam table).

### Retail Marketing Application

In this application there are two devices. First the Mobile shopper device is owned by a user and mapped to an org. The user is the customer who is holding the app containing the mobile shopper sdk. The Org is the retailer, the OEM or the display manufacturer. This allows the Org visibility into how customers are using their services. Because the device is mapped to a user (customer) the org can ask questions like “when is the last time this customer was in?”, “how often does this customer come in?”. The second device is the Mobile Helper device. This device is owned by a user (in this case an employee) but is mapped to a site. This allows us to communicate with all employees of a particular site at once. It also allows those employees to share data and interact on the same pieces of data. For example when a mobile shopper creates an instruction object (this instruction object would indicate a need for help with a box) the instruction can be picked up by every device mapped to the site. So a message would display on every mobile device mapped to that site. Then when an employee has taken care of the request she can acknowledge the instruction this action would remove the message from all the other devices mapped to the site.

### Home Builder Application

In this application there may be three devices. First the Mobile shopper device is owned by a user and mapped to an org. The user is the customer who is holding the app containing the mobile shopper sdk. The Org is the home builder. This allows the Org visibility into how customers are using their services. Because the device is mapped to a user (customer) the org can ask questions like “when is the last time this customer was in?”, “how often does this customer come in?”. The second device is the Mobile Helper device. This device is owned by a user (in this case a sales professional) but is mapped to a site. This allows us to communicate with all sales professional of a particular site at once. It also allows those sales professionals to share data and interact on the same pieces of data. For example when a mobile shopper creates an instruction object (this instruction object would indicate a need for information on custom counter top options) the instruction can be picked up by every device mapped to the site. So a message would display on every mobile device mapped to that site. Then when an sales professional has taken care of the request she can acknowledge the instruction this action would remove the message from all the other devices mapped to the site. The third kind of device would sense and report environmental data. This device is owned by the zone. but mapped to the org This configuration allows us to report on the conditions of a cohesive part of the home. For example the basement may have three water detectors. By creating a zone for basement we are able to report on the condition of the basement as a whole. Also because the device is mapped to the org we are able to communicate the conditions and alarm states to the org. This allows us to notify the builder directly in the case that there is water in the basement of one of their customers.

### Employee Engagement Application

The device in this application is the Mobile Helper device. This device is owned by a user (in this case a sales professional) but is mapped to a site. This allows us to communicate with all sales professional of a particular site at once. It also allows those sales professionals to share data and interact on the same pieces of data. For example, when a mobile shopper creates an instruction object (this instruction object would indicate a need for information on custom counter top options) the instruction can be picked up by every device mapped to the site. So a message would display on every mobile device mapped to that site. Then, when a sales professional has taken care of the request, she can acknowledge the instruction this action would remove the message from all the other devices mapped to the site.

### Manufacturing/Industrial Application

The first device is the Mobile Helper device. This device is owned by a user (in this case an employee) but is mapped to a site. This allows us to communicate with all sales professional of a particular site at once. It also allows those sales professionals to share data and interact on the same pieces of data. For example when a mobile shopper creates an instruction object (this instruction object would indicate a need for information on custom counter top options) the instruction can be picked up by every device mapped to the site. So a message would display on every mobile device mapped to that site. Then when an sales professional has taken care of the request she can acknowledge the instruction this action would remove the message from all the other devices mapped to the site.

### Sponsored Smart Home Application

The devices in this application would sense and report environmental data. These devices are owned by the user who is mapped to an org. The devices are mapped to the zone. This configuration allows us to report on the conditions of a cohesive part of the home. For example the basement may have three water detectors. By creating a zone for basement we are able to report on the condition of the basement as a whole. Also because the user is mapped to the org we are able to communicate the conditions and alarm states to the org. This allows us to notify the sponsor directly in the case that there is water in the basement of one of their customers.

### Billboard Advertising Application

In this application the device is the Mobile shopper device it is owned by a user and mapped to an org. The user is the customer who is holding the app containing the mobile shopper sdk. The Org is the owner of the billboards. This allows the Org visibility into how customers are using their services. Because the device is mapped to a user (customer) the org can ask questions like “when is the last time this customer was in?”, or “how often does this customer come in?”

### Hospitality Application

In this application there are three devices. First the Mobile shopper device is owned by a user and mapped to an org. The user is the customer who is holding the app containing the mobile shopper sdk. The Org is the hotel chain. This allows the hotel visibility into how customers are using their services. Because the device is mapped to a user (customer) the hotel can ask questions like “when is the last time this customer was in?”, “how often does this customer come in?”. The second device is the Mobile Helper device. This device is owned by a user (in this case an employee) but is mapped to a site. This allows us to communicate with all employees of a particular site at once. It also allows those employees to share data and interact on the same pieces of data. For example when a mobile shopper creates an instruction object (this instruction object would indicate a need for room service) the instruction can be picked up by every device mapped to the site. So a message would display on every mobile device mapped to that site. Then when an employee has taken care of the request she can acknowledge the instruction this action would remove the message from all the other devices mapped to the site. The third kind of device would sense and report environmental data. This device is owned by the zone. This configuration allows us to report on the conditions of a cohesive part of the hotel. For example the steam table in the kitchen may have three different steam bays. By creating a zone for steam table we are able to report on the condition of the steam table as a whole. Also it allows us to draw inferences about possible conditions by combining data from the three bays. For example we can compare the temperature of the three bays to infer the condition of the whole zone (in this case steam table).

### Theme Park Application

In this application there are three devices. First the Mobile shopper device is owned by a user and mapped to an org. The user is the customer who is holding the app containing the mobile shopper sdk. The Org is the park. This allows the park visibility into how customers are using their services. Because the device is mapped to a user (customer) the park can ask questions like “when is the last time this customer was in?”, “how often does this customer come in?”. The second device is the Mobile Helper device. This device is owned by a user (in this case an employee) but is mapped to a site. This allows us to communicate with all employees of a particular site at once. It also allows those employees to share data and interact on the same pieces of data. For example when a mobile shopper creates an instruction object (this instruction object would indicate a need for room service) the instruction can be picked up by every device mapped to the site. So a message would display on every mobile device mapped to that site. Then when an employee has taken care of the request she can acknowledge the instruction this action would remove the message from all the other devices mapped to the site. The third kind of device would sense and report environmental data. This device is owned by the zone. This configuration allows us to report on the conditions of a cohesive part of the park. For example the steam table in the kitchen may have three different steam bays. By creating a zone for steam table we are able to report on the condition of the steam table as a whole. Also it allows us to draw inferences about possible conditions by combining data from the three bays. For example we can compare the temperature of the three bays to infer the condition of the whole zone (in this case steam table).

### The Advertising Paradigm

Why is advertising important? Advertising is an important part of any IOT solution because it helps offset the costs of operation making the system and its applications more accessible to potential customers. How is it incorporated? Advertising is incorporated in the system through the concepts of Vendor, Campaign and through our integration with ad networks such as Facebook, Adwords, Pinterest, Twitter and Instagram. What is a vendor? A vendor in our system represents a third party which will display messages to the users of our system who are mapped to a specific Org. Typically a vendor will have a relationship with the Org which owns the devices or Users. For example Nike may want to send a message to a user while she is standing in the shoe department of a retail store. What is a campaign? A campaign is a timeboxed collection of messages and triggers defined and owned by an org or a vendor. What is a message? A message is all or part of a piece of content which will be displayed to a user in response to a trigger evaluating to true. What is a trigger? A trigger is an object which describes when device tolerances are exceeded. Using this object the system may discover: 1) when to trigger an alarm, and 2) which message to display to whom and how. Which signals should be triggered? The trigger contains a collection of rules each of which can be evaluated to true or false. Taken together they can describe a rich set of conditions. When the set of rules all evaluate to true the trigger is considered to evaluate to true. The trigger also contains a collection of messages and configurations for signals. What is a Signal? A signal contains the information needed to make a connection to an external system. For example a signal can contain information needed to add a user to a custom audience on Facebook. Another example would be a signal which contains information needed to make a connection to a plumbers dispatch and scheduling system. Descriptions as to advertising may be applied in example applications are given below.

### Escalator Maintenance TOT Application

In this application the device is a device which senses and records environmental conditions. In this case sensors which record the temperature of motors on the escalator bank. When one of the triggers has evaluated to true indicating that the tolerance of that device has been breached an alarm will be raised. When the alarm is raised a message will be sent to the designated admin of the org. When this happens we can insert an advertisement into the message. The advertisement will be defined by the vendor mapped to that org for that device.

### Restaurant Equipment TOT Application

The Restaurant application has three types of devices. The first type of device is the Mobile Shopper device. This device presents the opportunity for vendors to present messaging to customers of the restaurant at the optimal time. For example the customer could be presented a message from a vendor which sells alcohol to make a purchase when they approach the bar. This message would be presented in response to a trigger evaluating to true. When this happens a message can be retrieved from a campaign defined by the vendor and displayed on the device. The second type of device is the Mobile Helper. This device presents the opportunity for a vendor to present the employees of the restaurant a message which would help them explain benefits of a product. This message would be presented in response to a trigger evaluating to true. When this happens a message can be retrieved from a campaign defined by the vendor and displayed on the device. The third device is a device which senses and records environmental conditions. In this case sensors which record the temperature of a steam table. When one of the triggers has evaluated to true indicating that the tolerance of that device has been breached an alarm will be raised. When the alarm is raised a message will be sent to the designated admin of the org. When this happens we can insert an advertisement into the message. The advertisement will be defined by the vendor mapped to that org for that device.

### Retail Marketing Application

The Retail application has two types of devices. The first type of device is the Mobile Shopper device. This device presents the opportunity for vendors to present messaging to customers of the store at the optimal time. For example the customer could be presented a message from a vendor which sells shoes to make a purchase when they approach the shoe department. This message would be presented in response to a trigger evaluating to true. When this happens a message can be retrieved from a campaign defined by the vendor and displayed on the device. The second type of device is the Mobile Helper. This device presents the opportunity for a vendor to present the employees of the restaurant a message which would help them explain benefits of a product. This message would be presented in response to a trigger evaluating to true. When this happens a message can be retrieved from a campaign defined by the vendor and displayed on the device.

### Home Builder Application

The home builder application has three types of devices. The first type of device is the Mobile Shopper device. This device presents the opportunity for vendors to present messaging to customers of the home at the optimal time. For example the customer could be presented a message from a vendor which sells counter tops when they approach the kitchen in the model home. This message would be presented in response to a trigger evaluating to true. When this happens a message can be retrieved from a campaign defined by the vendor and displayed on the device. The second type of device is the Mobile Helper. This device presents the opportunity for a vendor to present the sales professional of the home a message which would help them explain benefits of a product. This message would be presented in response to a trigger evaluating to true. When this happens a message can be retrieved from a campaign defined by the vendor and displayed on the device. The third device is a device which senses and records environmental conditions. In this case sensors which record the water underneath the water heater. When one of the triggers has evaluated to true indicating that the tolerance of that device has been breached an alarm will be raised. When the alarm is raised a message will be sent to the home owner. When this happens we can insert an advertisement into the message. The advertisement will be defined by the vendor mapped to that org for that device.

### Employee Engagement Application

The device for this application is the Mobile Helper. This device presents the opportunity for a vendor to present the employee of the home a message which would help them explain benefits of a product. This message would be presented in response to a trigger evaluating to true. When this happens a message can be retrieved from a campaign defined by the vendor and displayed on the device.

### Manufacturing/Industrial Application

The device which could trigger advertising in this application is a device which senses and records environmental conditions. In this case sensors which record the temperature of a motor on some machine. When one of the triggers has evaluated to true indicating that the tolerance of that device has been breached an alarm will be raised. When the alarm is raised a message will be sent to the plant manager. When this happens we can insert an advertisement into the message. The advertisement will be defined by the vendor mapped to that org for that device.

### Sponsored Smart Home Application

The device which could trigger advertising in this application is a device which senses and records environmental conditions. In this case sensors which record the water underneath the water heater. When one of the triggers has evaluated to true indicating that the tolerance of that device has been breached an alarm will be raised. When the alarm is raised a message will be sent to the home owner. When this happens we can insert an advertisement into the message. The advertisement will be defined by the vendor mapped to that org for that device.

### Billboard Advertising Application

The device which could trigger advertising in this application is the Mobile shopper device. This device presents the opportunity for vendors to present messaging to customers electronically. The billboard owner can then sell his electronic space as well as the physical space on the billboard. Because of the advanced triggers and multiple messages the electronic space could be sold to numerous vendors. As a person walks or drives by the billboard, a message from a vendor which sells computers can be presented to the person. This message would be presented in response to a trigger evaluating to true. When this happens a message can be retrieved from a campaign defined by the vendor and displayed on the device.

### Hospitality Application

The hospitality application has three types of devices. The first type of device is the Mobile Shopper device. This device presents the opportunity for vendors to present messaging to customers of the hotel at the optimal time. For example the customer could be presented a message from a vendor which sells alcohol to make a purchase when they approach the bar. This message would be presented in response to a trigger evaluating to true. When this happens a message can be retrieved from a campaign defined by the vendor and displayed on the device. The second type of device is the Mobile Helper. This device presents the opportunity for a vendor to present the employees of the hotel a message which would help them explain benefits of a product. This message would be presented in response to a trigger evaluating to true. When this happens a message can be retrieved from a campaign defined by the vendor and displayed on the device. The third device is a device which senses and records environmental conditions. In this case sensors which record the temperature of a steam table. When one of the triggers has evaluated to true indicating that the tolerance of that device has been breached an alarm will be raised. When the alarm is raised a message will be sent to the designated admin of the org. When this happens we can insert an advertisement into the message. The advertisement will be defined by the vendor mapped to that org for that device.

### Theme Park Application

The theme park application has three types of devices. The first type of device is the Mobile Shopper device. This device presents the opportunity for vendors to present messaging to customers of the park at the optimal time. For example the customer could be presented a message from a vendor which balloons when they approach the game section. This message would be presented in response to a trigger evaluating to true. When this happens a message can be retrieved from a campaign defined by the vendor and displayed on the device. The second type of device is the Mobile Helper. This device presents the opportunity for a vendor to present the employees of the park a message which would help them explain benefits of a product. This message would be presented in response to a trigger evaluating to true. When this happens a message can be retrieved from a campaign defined by the vendor and displayed on the device. The third device is a device which senses and records environmental conditions. In this case sensors which record the temperature of a steam table. When one of the triggers has evaluated to true indicating that the tolerance of that device has been breached an alarm will be raised. When the alarm is raised a message will be sent to the designated admin of the org. When this happens we can insert an advertisement into the message. The advertisement will be defined by the vendor mapped to that org for that device.

### Alarms

What is an Alarm? An alarm is an object in the database which defines a message that must be sent to someone in response to a device being outside defined tolerances. Because our goal with alarms is guaranteed delivery the system has a separate process which cycles through the alarm objects and uses their configurations to send messages to selected people. Descriptions as to how alarms may work in example applications are given below.

### Escalator Maintenance TOT Application

In this application an alarm is created when the device monitoring the temperature of the motor is outside the defined tolerance for that device. This occurs when the rules within a trigger evaluate to true. An alarm is created in the database the cron job runs and uses the configurations in the alarm to send a message to the selected user.

### Restaurant Equipment TOT Application

This application has three devices. The first type of device is the Mobile Shopper device. In this device an alarm is triggered when the device encounters a zone which has a trigger which evaluates to true. When the alarm is raised a series of pre-defined Signals will be triggered alerting external systems to the alarm. Also a message may be shown to the user of the Mobile Shopper device. The second device in this application is the Mobile Helper device. In this device an alarm is triggered when the device encounters a zone which has a trigger which evaluates to true. When the alarm is raised a series of pre-defined Signals will be triggered alerting external systems to the alarm. Also a message may be shown to the user of the Mobile Helper device. The third device in this application is a device monitoring the temperature of the steam table and that determines when the temperature is outside the defined tolerance for that device. This occurs when the rules within a trigger evaluate to true. An alarm is created in the database the cron job runs and uses the configurations in the alarm to send a message to the selected user.

### Retail Marketing Application

This application has two devices. The first type of device is the Mobile Shopper device. In this device an alarm is triggered when the device encounters a zone which has a trigger which evaluates to true. When the alarm is raised a series of pre-defined Signals will be triggered alerting external systems to the alarm. Also a message may be shown to the user of the Mobile Shopper device. The second device in this application is the Mobile Helper device. In this device an alarm is triggered when the device encounters a zone which has a trigger which evaluates to true. When the alarm is raised a series of pre-defined Signals will be triggered alerting external systems to the alarm. Also a message may be shown to the user of the Mobile Helper device.

### Home Builder Application

This application has three devices. The first type of device is the Mobile Shopper device. In this device an alarm is triggered when the device encounters a zone which has a trigger which evaluates to true. When the alarm is raised a series of pre-defined Signals will be triggered alerting external systems to the alarm. Also a message may be shown to the user of the Mobile Shopper device. The second device in this application is the Mobile Helper device. In this device an alarm is triggered when the device encounters a zone which has a trigger which evaluates to true. When the alarm is raised a series of pre-defined Signals will be triggered alerting external systems to the alarm. Also a message may be shown to the user of the Mobile Helper device. The third device in this application is a device monitoring the temperature of the house and that determines when the temperature is outside the defined tolerance for that device. This occurs when the rules within a trigger evaluate to true. An alarm is created in the database the cron job runs and uses the configurations in the alarm to send a message to the selected user.

### Employee Engagement Application

This application has one device. The device in this application is the Mobile Helper device. In this device an alarm is triggered when the device encounters a zone which has a trigger which evaluates to true. When the alarm is raised a series of pre-defined Signals will be triggered alerting external systems to the alarm. Also a message may be shown to the user of the Mobile Helper device.

### Manufacturing/Industrial Application

This application has two devices. The first type of device in this application is the Mobile Helper device. In this device an alarm is triggered when the device encounters a zone which has a trigger which evaluates to true. When the alarm is raised a series of pre-defined Signals will be triggered alerting external systems to the alarm. Also a message may be shown to the user of the Mobile Helper device. The second device in this application is a device monitoring the temperature of the house and that determines when the temperature is outside the defined tolerance for that device. This occurs when the rules within a trigger evaluate to true. An alarm is created in the database the cron job runs and uses the configurations in the alarm to send a message to the selected user.

### Sponsored Smart Home Application

This application may have one device. The device in this application is a device monitoring the temperature of the house and that determines when the temperature is outside the defined tolerance for that device. This occurs when the rules within a trigger evaluate to true. An alarm is created in the database the cron job runs and uses the configurations in the alarm to send a message to the selected user. The alarm would also trigger communication with external systems such as an insurance company's crm system through the configured signals.

### Billboard Advertising Application

This application may have one device. The device is the Mobile Shopper device. In this device an alarm is triggered when the device encounters a zone which has a trigger which evaluates to true. When the alarm is raised a series of pre-defined signals will be triggered alerting external systems to the alarm. Also a message may be shown to the user of the Mobile Shopper device.

### Hospitality Application

This application has three devices. The first type of device is the Mobile Shopper device. In this device an alarm is triggered when the device encounters a zone which has a trigger which evaluates to true. When the alarm is raised a series of pre-defined Signals will be triggered alerting external systems to the alarm. Also a message may be shown to the user of the Mobile Shopper device. The second device in this application is the Mobile Helper device. In this device an alarm is triggered when the device encounters a zone which has a trigger which evaluates to true. When the alarm is raised a series of pre-defined Signals will be triggered alerting external systems to the alarm. Also a message may be shown to the user of the Mobile Helper device. The third device in this application is a device monitoring the temperature of the steam table and that determines when the temperature is outside the defined tolerance for that device. This occurs when the rules within a trigger evaluate to true. An alarm is created in the database the cron job runs and uses the configurations in the alarm to send a message to the selected user.

### Theme Park Application

This application has three devices. The first type of device is the Mobile Shopper device. In this device an alarm is triggered when the device encounters a zone which has a trigger which evaluates to true. When the alarm is raised a series of pre-defined Signals will be triggered alerting external systems to the alarm. Also a message may be shown to the user of the Mobile Shopper device. The second device in this application is the Mobile Helper device. In this device an alarm is triggered when the device encounters a zone which has a trigger which evaluates to true. When the alarm is raised a series of pre-defined signals will be triggered alerting external systems to the alarm. Also a message may be shown to the user of the Mobile Helper device. The third device in this application is a device monitoring the temperature of the steam table and determining when the temperature is outside the defined tolerance for that device. This occurs when the rules within a trigger evaluate to true. An alarm is created in the database the cron job runs and uses the configurations in the alarm to send a message to the selected user.

### Social Connections

The social connections of the Advos system may include a connection to Facebook, Google Adwords, Pinterest, instagram and/or Twitter, for example. These connections allow our system to do two very important things. First, we can enable business for the first time to use the data on social networks to learn about their in store customers in a whole new way. Never before has the retailer been able to ask questions like “Of the people in my store last week, how many are in the market for a new house?” or “Of the people in my shoe department this month, how many make more money than 50k?” Through the micro-location based intelligence of Advos and the personalized metrics of social networks we enable businesses to get to know their customers on a whole new level. Second, our connections with the social networks enable our customers to re-target customers based on actions they take in physical space. For example imagine you are the owner of a liquor store. A customer interacts with an Advos Smart Tag displayed near the imported whisky. They waive their phone at it and get a description of the 10 year process in making this whisky. When they make this interaction the Advos system connects with the social networks and adds them to a custom audience. Later, the can be re-targeted with ads using the social networks ad platforms. They can be sent a message across the web and mobile sphere letting them know of a new special whisky you have on hand. This message may only be sent to the customers who have shown interest in whisky by interacting with the whisky tag in your store.

The paradigm of custom audiences on the social networks ad platforms is rather new but is currently possible with a number of social networking services. Advos's ability to record physical events and create custom audiences based on those events presents companies with a whole new way to react to customers needs. They can react to customers' needs even before the customer knows they have a problem. For example, if you have water on your basement floor, the Advos for Smart home application can detect this condition. Once detected Advos can message you that there is water but we can also give you the name of a plumber in your area and notify your insurance adjuster to come out and check up on you. We can then continue the conversation to ensure that the problem was taken care of. This presents a whole new flow and opportunity to customer relations for our customers. Descriptions of social connections in different example applications are given below.

### Restaurant Equipment TOT Application

This application has one device that can utilize social connections. A typical business owner would like to know more about the demographics of its customers. To be able to draw rich demographic data based on the people who visit my business would be a great help. This information can be used to help target additional customers and to cater the service and business to the demographic of customers. Additionally, it would be advantageous to be able to capture a list of everyone who visits the business. Curated messages could then be sent to them based on what parts of my business they engaged with, when they visited and what they did while they were there.

### Retail Marketing Application

This application has one device that can utilize social connections. A business owner would like to know more about the demographics of her customers. To be able to draw rich demographic data based on the people who visit her business would be a great help. This information can be used to help target additional customers and to cater the service and business to the demographic of those customers. Additionally, it would be advantageous to be able to capture a list of everyone who visits the business. They could be sent curated messages based on what parts of the business they engaged with, when they visited, and what they did while they were there.

### Home Builder Application

This application has two devices that can utilize social connections. A home builder would like to know more about the demographics of the people who visit her model homes. To be able to draw rich demographic data based on the people who visit her models would be a great help. This information can be used to help target additional customers and to cater the service and business to the demographic of those customers. Additionally, it would be advantageous to be able to capture a list of everyone who visits the models. They could be sent curated messages based on what parts of the business they engaged with, when they visited, and what they did while they were there. The other type of device which could use social connections is the device which monitors environmental conditions of the home once it is built. For example a device which detects water in the basement could create a custom audience that I could engage with further messaging and help them through the entire clean-up process after a flood.

### Sponsored Smart Home Application

The type of device in this application which could use social connections is the device which monitors environmental conditions of the home. For example a device which detects water in the basement could create a custom audience that I could engage with further messaging and help them through the entire clean-up process after a flood.

### Billboard Advertising Application

This application has one device that can utilize social connections. A business owner would like to know more about the demographics of her customers. To be able to draw rich demographic data based on the people who visit the business would be a great help. This information can be used to help target additional customers and to cater the service and business to the demographic of those customers. Additionally, it would be advantageous to be able to capture a list of everyone who visits my business. Those customers could be sent curated messages based on what parts of the business they engaged with, when they visited, and what they did while they were there.

### Hospitality Application

This application has one device that can utilize social connections. A business owner would like to know more about the demographics of her customers. To be able to draw rich demographic data based on the people who visit the business would be a great help. This information can be used to help target additional customers and to cater the service and business to the demographic of those customers. Additionally, it would be advantageous to be able to capture a list of everyone who visits my business. Those customers could be sent curated messages based on what parts of the business they engaged with, when they visited, and what they did while they were there.

### Theme Park Application

This application has one device that can utilize social connections. A business owner would like to know more about the demographics of her customers. To be able to draw rich demographic data based on the people who visit the business would be a great help. This information can be used to help target additional customers and to cater the service and business to the demographic of those customers. Additionally, it would be advantageous to be able to capture a list of everyone who visits my business. Those customers could be sent curated messages based on what parts of the business they engaged with, when they visited, and what they did while they were there.

### CONCLUSION

The Advos platform as described herein is a robust, flexible, extensible and scalable TOT device management platform. It is built to allow enterprise orgs to manage and monitor all of their TOT devices remotely. It may be used in a number of different industries including the retail environment. It allows retailers to really engage their customers in store in a way they have never done before. Through beacons, Smart Tags and our suite of mobile ready SDKs, a retailer can produce applications that will allow customers to interact with the store to find additional information, share what they find and receive content from their favorite stores that is personalized to their individual needs. The retailer will be able to understand their customers' interactions with their stores in a new way. By examining the in store analytics, they can understand how customers move through the store and which sections are engaging and which are not. In addition the retailer can use their store to drive additional revenue streams by partnering with vendors to market to customers in store and out with additional rich sets of custom audiences.

### Further Example Embodiments

In Example 1, an Internet of Things management system, comprises: a host computing platform including processing circuitry, storage media, and a network interface; a services layer executing in the host computing platform, wherein the services layer maintains a database with one or more organizations as top-level data objects, carries out business rules and functions for the organization, and communicates with one or more mobile computing devices over a network; one or more beacon devices deployed at locations which define one or more zones within a geographic site belonging to the organization, the beacon devices being configured to wirelessly broadcast a location ID (identification) for reception by a mobile computing device; a user application executing in each mobile device configured to communicate the location ID from a beacon device and a mobile computing device ID to the services layer; and, wherein the services layer is configured to respond to reception of location and mobile computing device IDs by executing an instruction as specified by the organization's business rules.

In Example 2, the subject matter of Example 1 or any of the Examples described herein may further include wherein the user application is a mobile shopper application for use by customers of the organization when visiting the organization's site.

In Example 3, the subject matter of Example 1 or any of the Examples described herein may further include wherein the mobile shopper application is configured to automatically communicate the location ID and the mobile computing device ID to the services layer if a signal strength of the received location ID broadcasted by the beacon device is above a specified threshold.

In Example 4, the subject matter of Example 1 or any of the Examples described herein may further include wherein the mobile shopper application is configured to communicate the location ID and the mobile computing device ID to the services layer if a signal strength of the received location ID broadcasted by the beacon device is above a specified threshold for a specified period of time.

In Example 5, the subject matter of Example 1 or any of the Examples described herein may further include wherein the mobile shopper application is configured to communicate the location ID and the mobile computing device ID to the services layer when initiated to do so by the user of the mobile computing device.

In Example 6, the subject matter of Example 1 or any of the Examples described herein may further include wherein the mobile shopper application is configured so that the user initiates communication of the location ID and the mobile computing device ID to the services layer when the user uses the mobile computing device to interact with a smart tag.

In Example 7, the subject matter of Example 1 or any of the Examples described herein may further include wherein the services layer is configured to add a user ID associated with the user to a custom audience at a social media site in response to receiving the location ID and the mobile computing device ID.

In Example 8, the subject matter of Example 1 or any of the Examples described herein may further include wherein the services layer is configured to communicate a zone payload to the mobile computing device in response to receiving the location ID and mobile computing device ID.

In Example 9, the subject matter of Example 1 or any of the Examples described herein may further include wherein the zone payload contains information that instructs the mobile shopper application to open another application to be executed by the mobile computing device.

In Example 10, the subject matter of Example 1 or any of the Examples described herein may further include wherein the zone payload contains information that instructs the mobile shopper application to download product information.

In Example 11, the subject matter of Example 1 or any of the Examples described herein may further include wherein the services layer is configured to, in response to receiving the location ID and mobile computing device ID, transmit the location ID to a guest assist application executed by a mobile computing device belonging to an employee of the organization.

In Example 12, the subject matter of Example 1 or any of the Examples described herein may further include wherein the guest assist application is configured to transmit an acknowledgement signal to the services layer when instructed to do so by the employee.

In Example 13, the subject matter of Example 1 or any of the Examples described herein may further include wherein the services layer is configured to transmit to the guest assist application a list of customers in need of help as derived from received location and mobile computing device IDs.

In Example 14, the subject matter of Example 1 or any of the Examples described herein may further include wherein the services layer is configured to, in response to receiving the location ID and mobile computing device ID, transmit a personalized message to the mobile shopper application.

In Example 15, the subject matter of Example 1 or any of the Examples described herein may further include wherein the user application is an employee application executed by a mobile computing device belonging to an employee of the organization.

In Example 16, the subject matter of Example 1 or any of the Examples described herein may further include wherein the employee application is configured to automatically communicate the location ID and the mobile computing device ID to the services layer if a signal strength of the received location ID broadcasted by the beacon device is above a specified threshold.

In Example 17, the subject matter of Example 1 or any of the Examples described herein may further include wherein the services layer is configured to record the movements of the employee within the organization's site based upon received location and mobile computing device IDs.

In Example 18, the subject matter of Example 1 or any of the Examples described herein may further include one or more sensor devices attached to mechanical equipment at the organization's site that are configured to report an operating status of the mechanical equipment to the services layer.

In Example 19, the subject matter of Example 1 or any of the Examples described herein may further include wherein the services layer is configured to, upon receiving an operating status report from a sensor device indicating an equipment malfunction, transmit a message to the employee application.

In Example 20, the subject matter of Example 1 or any of the Examples described herein may further include wherein the services layer is configured to, upon receiving an operating status report from a sensor device indicating an equipment malfunction, transmit a message to a vendor of the mechanical equipment.

In Example 21, a non-transitory computer-readable medium comprises instructions to cause a computing platform, upon execution of the instructions by processing circuitry of the computing platform, to perform the functions set forth in any of Examples 1 through 20.

In Example 22, a method comprises performing the functions as set forth in any of Examples 1 through 20.

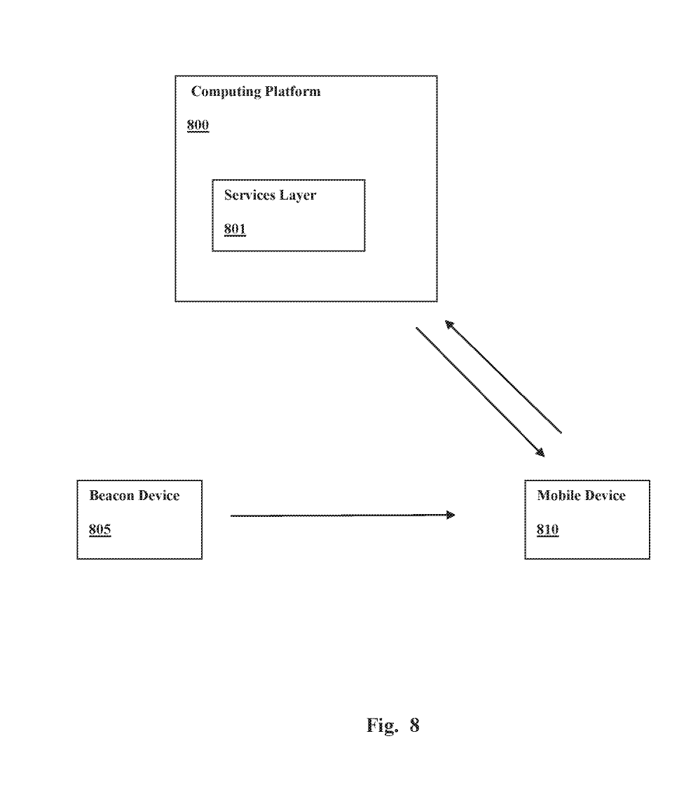

FIG. 8 illustrates an Internet of Things management system according to one embodiment. A computing platform 800 includes processing circuitry, storage media, and a network interface. The network interface may provide Internet and/or local area network (e.g., Wi-Fi) connectivity. A services layer 801 is executed either directly by the computing platform 800 either or via a cloud computing platform with which the computing platform communicates via the network interface. One or more beacon devices 805 are deployed that include circuitry for wirelessly broadcasting (e.g., via Wi-Fi or Bluetooth) a location ID (identification) for reception by one or more mobile computing devices 810 (e.g., smart phones). The mobile computing devices 810 communicate with the services layer via the network interface of the computing platform.

This application is intended to cover adaptations or variations of the present subject matter. It is to be understood that the above description is intended to be illustrative, and not restrictive. The subject matter has been described in conjunction with the foregoing specific embodiments. It should be appreciated that those embodiments may also be combined in any manner considered to be advantageous. Also, many alternatives, variations, and modifications will be apparent to those of ordinary skill in the art. Other such alternatives, variations, and modifications are intended to fall within the scope of the following appended claims.

What is claimed is:

1. An Internet of Things management system, comprising:
a host computing platform including processing circuitry, storage media, and a network interface;
a services layer executing in the host computing platform, wherein the services layer maintains a database with one or more organizations as top-level data objects, carries out business rules and functions for the organization, and communicates with one or more mobile computing devices over a network;
one or more beacon devices deployed at locations which define one or more zones within a geographic site belonging to the organization, the beacon devices being configured to wirelessly broadcast a location ID (identification) for reception by a mobile computing device;
a user application executing in each mobile device configured to communicate the location ID from a beacon device and a mobile computing device ID to the services layer; and,
wherein the services layer is configured to respond to reception of location and mobile computing device IDs by executing an instruction as specified by the organization's business rules.

2. The system of claim 1 wherein the user application is a mobile shopper application for use by customers of the organization when visiting the organization's site.

3. The system of claim 2 wherein the mobile shopper application is configured to automatically communicate the location ID and the mobile computing device ID to the services layer if a signal strength of the received location ID broadcasted by the beacon device is above a specified threshold.

4. The system of claim 2 wherein the mobile shopper application is configured to communicate the location ID and the mobile computing device ID to the services layer if a signal strength of the received location ID broadcasted by the beacon device is above a specified threshold for a specified period of time.

5. The system of claim 2 wherein the mobile shopper application is configured to communicate the location ID and the mobile computing device ID to the services layer when initiated to do so by the user of the mobile computing device.

6. The system of claim 5 wherein the mobile shopper application is configured so that the user initiates communication of the location ID and the mobile computing device ID to the services layer when the user uses the mobile computing device to interact with a smart tag.

7. The system of claim 2 wherein the services layer is configured to add a user ID associated with the user to a custom audience at a social media site in response to receiving the location ID and the mobile computing device ID.

8. The system of claim 2 wherein the services layer is configured to communicate a zone payload to the mobile computing device in response to receiving the location ID and mobile computing device ID.

9. The system of claim 8 wherein the zone payload contains information that instructs the mobile shopper application to open another application to be executed by the mobile computing device.

10. The system of claim 8 wherein the zone payload contains information that instructs the mobile shopper application to download product information.

11. The system of claim 7 wherein the services layer is configured to, in response to receiving the location ID and mobile computing device ID, transmit the location ID to a guest assist application executed by a mobile computing device belonging to an employee of the organization.

12. The system of claim 11 wherein the guest assist application is configured to transmit an acknowledgement signal to the services layer when instructed to do so by the employee.

13. The system of claim 11 wherein the services layer is configured to transmit to the guest assist application a list of customers in need of help as derived from received location and mobile computing device IDs.

14. The system of claim 2 wherein the services layer is configured to, in response to receiving the location ID and mobile computing device ID, transmit a personalized message to the mobile shopper application.

15. The system of claim 1 wherein the user application is an employee application executed by a mobile computing device belonging to an employee of the organization.

16. The system of claim 15 wherein the employee application is configured to automatically communicate the location ID and the mobile computing device ID to the services layer if a signal strength of the received location ID broadcasted by the beacon device is above a specified threshold.

17. The system of claim 16 wherein the services layer is configured to record the movements of the employee within the organization's site based upon received location and mobile computing device IDs.

18. The system of claim 15 further comprising one or more sensor devices attached to mechanical equipment at the organization's site that are configured to report an operating status of the mechanical equipment to the services layer.

19. The system of claim 18 wherein the services layer is configured to, upon receiving an operating status report from a sensor device indicating an equipment malfunction, transmit a message to the employee application.

20. The system of claim 18 wherein the services layer is configured to, upon receiving an operating status report from a sensor device indicating an equipment malfunction, transmit a message to a vendor of the mechanical equipment.
